(19) United States
(12) Patent Application Publication
(10) Pub. No.: US 2002/0069764 A1
(43) Pub. Date: Jun. 13, 2002

(54) Cooking apparatus with cycling heat element

(76) Inventor: Maryjo Rose Cohen, Eau Claire, WI (US)

Correspondence Address: MERCHANT & GOULD PC, P.O. BOX 2903, MINNEAPOLIS, MN, 55402-0903, US

(21) Appl. No.: 09/733,649

(22) Filed: Dec. 8, 2000

(51) Int. Cl. A23L 1/00; A47J 27/62; H05B 1/02

(52) U.S. Cl. 99/331; 426/523; 219/492

(57) ABSTRACT

A cooking apparatus is provided which includes a food support member for supporting a food item thereon. The cooking apparatus further includes upper and lower housings disposed above and beneath the food support member. The upper and lower housings include an upper and lower heating member respectively. The cooking apparatus further includes a control unit which provides for cyclical heating by varying the heating members on and off to cook the food item located on the food support member.

### FIELD OF THE INVENTION

This invention generally relates to the field of electric ovens and more particularly to a cooking apparatus for cooking food items such as a pizza.

### BACKGROUND OF THE INVENTION

In the field of food preparation and particularly cooking of pizzas, it is well known to utilize a conventional electric oven. However, several common problems are associated with using a conventional oven such as having to wait to preheat the oven to begin cooking and uneven cooking of the pizza in the oven. For example, a conventional oven often has hot spots where heat is concentrated in a particular area in the oven and this leads to overcooking a portion of the pizza adjacent the hot spot while other portions of the pizza may not be fully cooked. Often it is difficult to ensure that the crust of the pizza is fully cooked without overcooking the top of the pizza.

In view of the problems associated with using a conventional oven to cook a pizza, it is known in the field of electric ovens to have an electric oven specifically designed for cooking pizzas or other similar types of foods. For example, U.S. Pat. No. 5,496,987 is directed to an electric oven particularly designed for cooking pizzas. In such a device, the oven includes heating coils which are supported above a base portion of the oven so that an entire pizza can be positioned between the coils for cooking a pizza. U.S. Pat. No. 5,586,488 discloses a portable pizza oven which includes a fixed upper and lower casing having an upper heating assembly and a lower heating assembly located within the casings. A pan is insertable into the cooking chamber so that the entire pizza is disposed between the upper and lower heater assemblies to cook the pizza. Both of these references apply continuous heat to the pizza which may potentially result in uneven cooking of the pizza.

What is needed is an apparatus which provides for fast, efficient cooking of a food item such as a pizza and which cooks a pizza evenly by applying a cyclic heat process to the pizza in which the heat is turned on and off in a cyclical manner to cook the pizza.

### SUMMARY OF THE INVENTION

The present invention is directed to a cooking apparatus which allows for fast, efficient cooking of a food item such as a pizza. According to one aspect of the present invention, a cooking apparatus is provided which includes a food support member for retaining a food item thereon. The cooking apparatus further includes upper and lower housings disposed above and beneath the food support member. The upper and lower housings include an upper and lower heating member respectively. The apparatus includes a control system which controls the application of heat from the heating members in which the control system provides for cyclic heating by periodically turning on and off the heating elements to cook the pizza.

### BRIEF DESCRIPTION OF THE DRAWINGS

FIG. 1 is a perspective view of one preferred embodiment of a cooking apparatus according to the principles of the present invention with portions cut away for viewing internal features.

FIG. 2 is a schematic of the control system.

FIG. 3 is a flow chart showing one method of operation.

### DETAILED DESCRIPTION OF THE PREFERRED EMBODIMENT

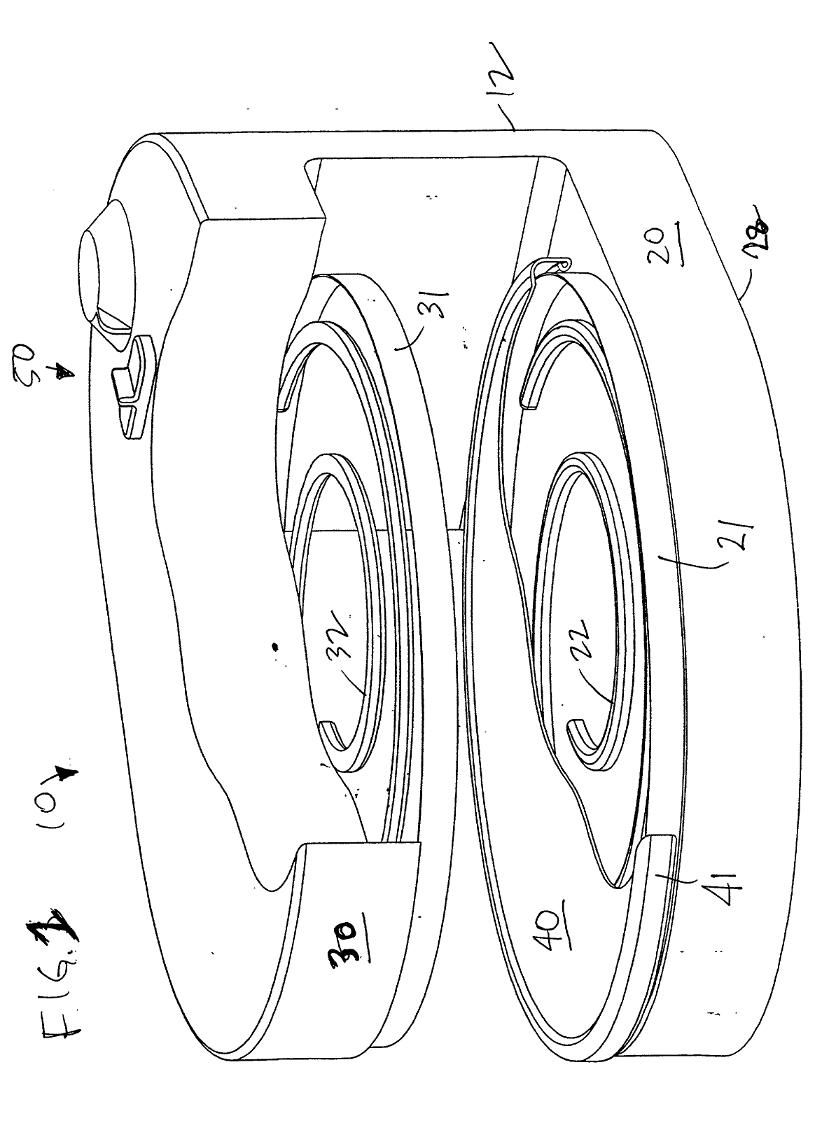

Referring now to the drawings in which one embodiment is numbered throughout, a description of the preferred embodiment is provided. In FIG. 1, a perspective view of a cooking apparatus according to the principles of the present invention is generally illustrated at 10. The cooking apparatus generally includes a base portion 12 and a lower housing 20 and an upper housing 30 extending forward from the base portion 12. A bottom surface 28 of lower housing 20 rests on a counter top or table top. The lower housing 20 includes a heating member 22. The upper housing 30 extends forward from the base 12 of the pizza cooking apparatus 10 at a position above the lower housing 20. The upper housing 30 is preferably positioned at approximately the same radial position as the lower housing 20. The upper housing 30 includes a heating member 32 disposed at a lower bottom portion of the upper housing facing a food support member 40 positioned over the lower heating member 22.

It is appreciated that the cooking apparatus may be utilized to cook a variety of food items. For example, the cooking apparatus may be used to cook frozen pizzas, as well as hot hors d'oeuvres or sandwiches. In the following description of a preferred embodiment, the cooking apparatus 10 will be described in the context of cooking a frozen pizza as a particular example of the present invention. Accordingly, the food support member 40 which is disposed between the upper and lower housings will be referred to as the pizza support member 40.

Preferably, the upper and lower housings 20, 30, respectively, enclose the pizza support member 40 so that the heating members of the upper and lower housing are able to apply heat to substantially the entire portion of the pizza on the pizza support member. Pizza support member 40 is disposed horizontally, and is preferably made of metal.

The cooking apparatus 10 includes a control unit 50 which is used to control the operation of the heating members 22, 32. In a preferred embodiment, the upper and lower heating members 22, 32 constitute sheathed metal heating elements. The sheathed metal heating elements are arranged in any desired pattern to provide the desired heating of the food item. The housings 20, 30 include rims 21, 31. The support member 40 is preferably solid in the horizontal direction, and includes a downwardly extending rim 41 outside of the rim 31 of the lower housing 30.

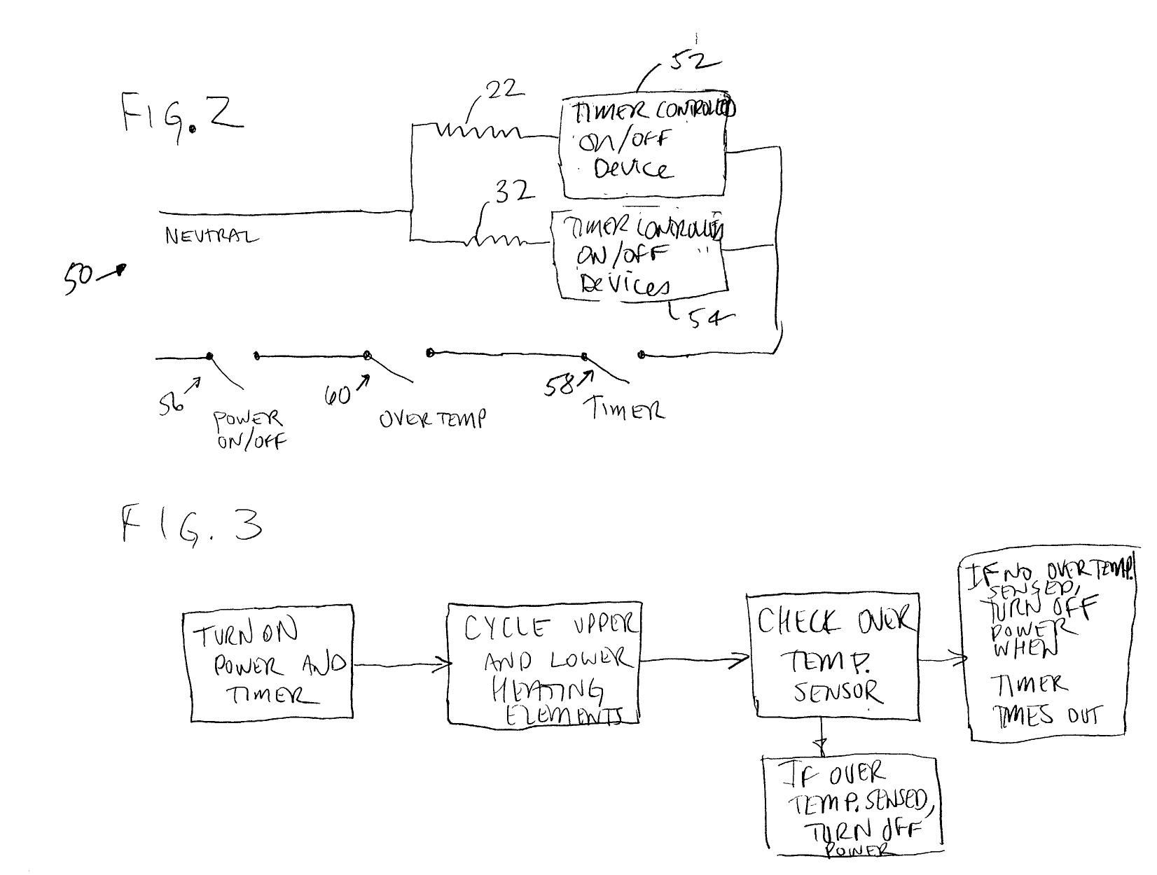

The control unit 50 is designed to apply cyclical heat to the pizza support member 40. Accordingly, the control unit operates through timer controlled devices 52, 54 to periodically turn on and off the heating members 22, 32 of the upper and lower housing so that when the heating members are on, a significant amount of heat is provided to the food support member to cook the item. Accordingly, when the control unit 50 periodically turns the heating members off, the food item is able to continue to cook but at a different pace than when the heating members are on. Accordingly, this cyclical heating through varying the heating members on and off provides for the cyclical heating of the food item. A power on/off switch 56, a timer 58, and an oven-temperature sensor 60 are provided in the control unit 50. FIGS. 2 and 3 show preferred features of the control unit 50 and one method of operation.

It is to be understood that even though numerous characteristics of various embodiments of the present invention have been set forth in the foregoing description, together with details of the structure and function of various embodiments of the invention, this disclosure is illustrative only and changes may be made in the details, especially in matters of shape, size, and arrangement of parts within the principles of the present invention to the full extent indicated by the broad general meaning in which the appended claims are expressed. All alternative modifications and variations which fall within the spirit and broad scope of the appended claims are covered.

What is claimed is:

1. A cooking apparatus comprising:
a generally circular food support member for supporting a food item thereon, the food support member adapted to be disposed in a substantially horizontal orientation;
upper and lower housings disposed above and beneath the food support member such that the upper and lower housings cover the food support member, the upper and lower housings each including an upper and lower heating member respectively; and, a control unit in connection with the heating elements such that the control unit provides for cyclical heating from the upper and lower heating members by periodically turning on and off the upper and lower heating members to cook the food item.

2. The cooking apparatus of claim 1, wherein the upper and lower heating members are sheathed metal heating elements.

3. The cooking apparatus of claim 2, wherein the control unit includes a timer controlled power on/off device for each upper and lower heating member.

4. A method of cooking a pizza comprising the steps of:
placing a pizza in an oven having upper and lower heating members;
setting a predetermined cooking time for a control unit for controlling heating of the upper and lower heating members;
cyclically heating each of the upper and lower heating members for predetermined cyclical times of heating and non-heating during the predetermined cooking time;
stopping the cyclical heating step after the predetermined cooking time has elapsed.
